(19) United States
(12) Patent Application Publication
(10) Pub. No.: US 2020/0274432 A1
(43) Pub. Date: Aug. 27, 2020

(54) VIBRATION GENERATING DEVICE

(71) Applicant: ALPS ALPINE CO., LTD., Tokyo (JP)

(72) Inventor: Tomokuni WAUKE, Tokyo (JP)

(21) Appl. No.: 15/931,952

(22) Filed: May 14, 2020

Related U.S. Application Data
(63) Continuation of application No. PCT/JP2018/042187, filed on Nov. 14, 2018.

(30) Foreign Application Priority Data
Nov. 20, 2017 (JP) 2017-223134

(51) Int. Cl. H02K 33/06; G08B 6/00

(52) U.S. Cl. CPC H02K 33/06; G08B 6/00

(57) ABSTRACT

A vibration generating device includes a housing, first and second vibrating bodies arranged in a first direction, an elastic support portion supporting the first and second vibrating bodies so as to be vibratable along the first and second directions, and a magnetic drive portion including a first magnetic generating unit provided in the first vibrating body and a second magnetic generating unit provided in the housing, the magnetic drive portion driving the first vibrating body along the first and second directions, wherein the elastic support portion includes a first elastic body coupling the first vibrating body to the housing so that the first vibrating body is movable in the first and second directions, a second elastic body coupling the first vibrating body to the second vibrating body, and a third elastic body coupling the second vibrating body to the housing so that the second vibrating body is movable.

### CROSS-REFERENCE TO RELATED APPLICATIONS

The present application is a continuation application of International Application No. PCT/JP2018/042187, filed Nov. 14, 2018, which claims priority to Japanese Patent Application No. 2017-223134, filed Nov. 20, 2017. The contents of these applications are incorporated herein by reference in their entirety.

### BACKGROUND OF THE INVENTION

### 1. Field of the Invention

The present invention relates to a vibration generating device.

### 2. Description of the Related Art

Conventionally, in an electronic apparatus such as a portable information terminal (e.g., a smartphone, mobile phone, tablet, etc.), a game machine, an information display device mounted in a vehicle such as an automobile, a vibration generating device capable of generating vibrations for notifying various incomings (e.g., incoming call, incoming mail, and incoming SNS) and for tactilely providing feedback to a user operation is used.

As a vibration generating device, for example, Patent Document 1 discloses a vibration generating device, in which a vibrating body composed of an electromagnet is vibratably supported by an elastic support portion. The vibrating body is vibrated in up and down directions at a first resonant frequency and in right and left directions at a second resonant frequency.

### PATENT DOCUMENT 1

Japanese Laid-Open Patent Application No. 2016-96677

### SUMMARY OF THE INVENTION

In recent years, however, the intended end-usages of vibration generating devices have diversified. For example, in a game machine that supports VR (Virtual Reality), a vibration generating device is used as a tactile presenting measure for reproducing a highly realistic tactile sensation. Accordingly, a variety of vibrations are required to be reproducible by the vibration generating device.

One possible way to reproduce a highly realistic tactile sense is to combine a plurality of vibrations with different resonant frequencies. In this case, by allowing the vibration generating device to generate more vibrations at more number of resonant frequencies, vibration combinations can be more diversified, allowing highly realistic tactile sensations to be reproduced more variously.

However, in the conventional vibration generating device, the number of resonant frequencies is relatively small (for example, the vibration generating device of the above-described Patent Document 1 is two). Therefore, it is difficult to reproduce the highly realistic tactile sensation in a more diverse manner. Thus, there is a need for the vibration generating device capable of generating vibrations at more resonant frequencies.

A vibration generating device includes a housing, a first vibrating body and a second vibrating body that are received inside the housing so as to be arranged in a first direction, an elastic support portion supporting the first vibrating body and the second vibrating body so as to be vibratable along the first direction and a second direction intersecting the first direction, and a magnetic drive portion including a first magnetic generating unit provided in the first vibrating body and a second magnetic generating unit provided in the housing, the magnetic drive portion being configured to drive the first vibrating body along the first direction and the second direction using magnetic force, wherein the elastic support portion includes a first elastic body coupling the first vibrating body to the housing so that the first vibrating body is movable in the first direction and the second direction, a second elastic body coupling the first vibrating body to the second vibrating body, and a third elastic body coupling the second vibrating body to the housing so that the second vibrating body is movable in the first direction and the second direction.

### BRIEF DESCRIPTION OF THE DRAWINGS

FIG. 1 is a perspective view illustrating a vibration generating device according to an embodiment.

FIG. 2 is a plan view illustrating the vibration generating device (with an upper casing removed) according to the embodiment.

FIG. 3 is an exploded view of the vibration generating device according to the embodiment.

FIG. 4 is a perspective view illustrating a vibration unit provided by the vibration generating device according to the embodiment.

FIG. 5 is a front view illustrating the vibration unit provided by the vibration generating device according to the embodiment.

FIG. 6 is a side view illustrating the vibration unit provided by the vibration generating device according to the embodiment.

FIG. 7 is an exploded view of the vibration unit provided by the vibration generating device according to the embodiment.

FIG. 8 is a perspective view illustrating an elastic support portion provided by the vibration generating device according to the embodiment.

FIG. 9 is a plan view illustrating the elastic support portion provided by the vibration generating device according to the embodiment.

FIG. 10 is a front view illustrating the elastic support portion provided by the vibration generating device according to the embodiment.

FIG. 11 is a side view illustrating the elastic support portion provided by the vibration generating device according to the embodiment.

FIG. 12 is a partial enlarged view of the vibration generating device according to the embodiment.

FIG. 13 is a view for explaining a state of magnetization of a permanent magnet provided by the vibration generating device according to the embodiment.

FIG. 14A is a view for explaining the operation of the vibrating body provided by the vibration generating device according to the embodiment.

FIG. 14B is a view for explaining the operation of the vibrating body provided by the vibration generating device according to the embodiment.

FIG. 15 is a view for explaining the operation of the vibrating body provided by the vibration generating device according to the embodiment.

FIG. 16 is a view for explaining the operation of the vibrating body provided by the vibration generating device according to the embodiment.

FIG. 17 is a view for explaining the operation of the vibrating body provided by the vibration generating device according to the embodiment.

FIG. 18 is a view for explaining the operation of the vibrating body provided by the vibration generating device according to the embodiment.

FIG. 19 is a graph illustrating the vibration characteristics of the vibration generating device in accordance with the embodiment.

FIG. 20 is a front view illustrating a modification of the vibration unit provided by the vibration generating device according to the embodiment.

### DESCRIPTION OF THE EMBODIMENTS

Hereinafter, an embodiment will be described with reference to the figures.

### (Structure of Vibration Generating Device 10)

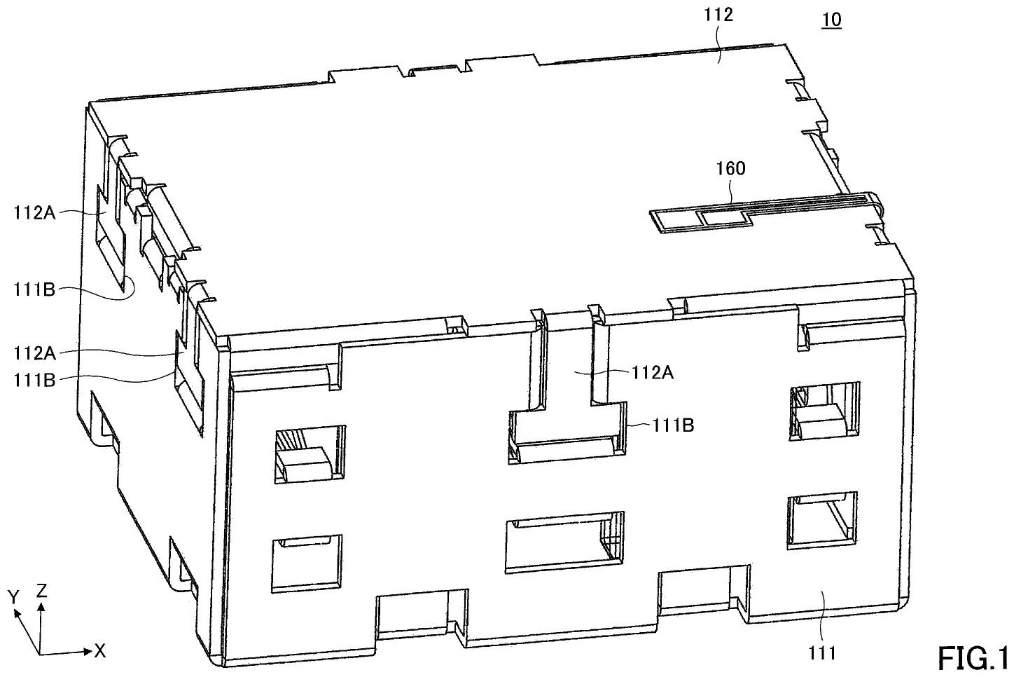

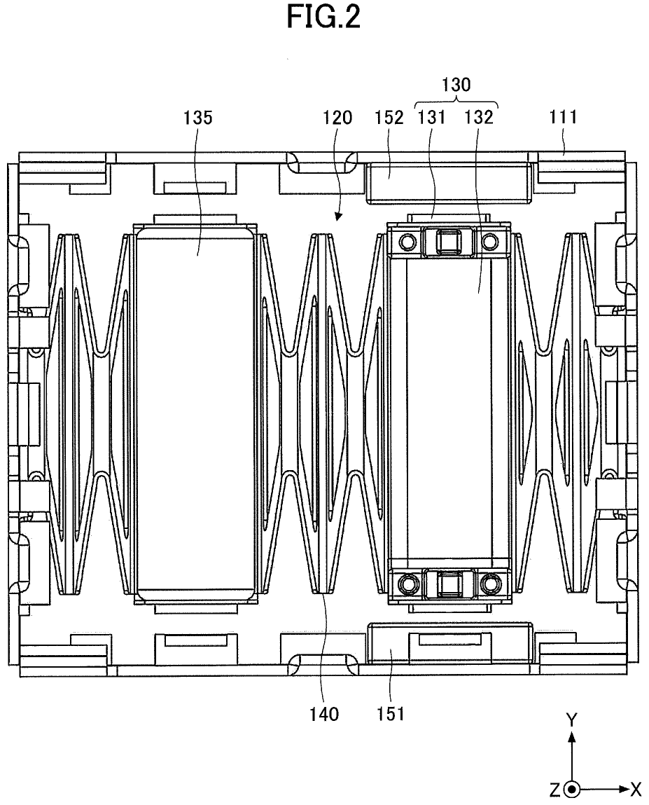

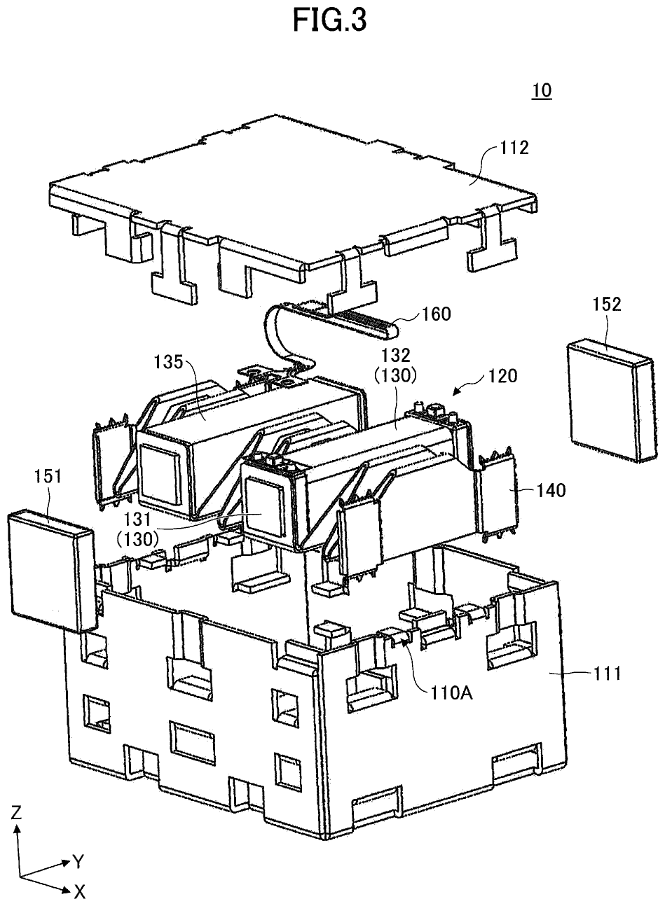

FIG. 1 is a perspective view illustrating a vibration generating device 10 according to an embodiment. FIG. 2 is a plan view illustrating the vibration generating device 10 (with an upper casing 112 and an FPC 160 removed) according to the embodiment. FIG. 3 is an exploded view of the vibration generating device 10 according to the embodiment. In the following description, for convenience, the Z-axis direction in the figure is set to longitudinal directions or up and down directions, the X-axis direction in the figure is set to lateral directions or right and left directions, and the Y-axis direction in the figure is set to front and back directions.

The vibration generating device 10 illustrated in FIGS. 1 to 3 is a device installed in an electronic device such as an information display device installed in a portable information terminal (e.g., a smartphone, a cellular phone, a tablet terminal, or the like), a game machine, or an information display apparatus installed in a vehicle such as a car. The vibration generating device 10 is used, for example, to generate vibrations for notifying various incomings (for example, incoming calls, incoming mail, incoming SNS) or vibrations for tactilely providing the user with feedback on user operation.

The vibration generating device 10 is configured so that the vibrating body 130 disposed inside a housing 110 vibrates along the up and down directions (the Z-axis direction in the figure) and the right and left direction (the X-axis direction in the figure). In particular, the vibration generating device 10 according to this embodiment generates vibrations at more numbers of the resonant frequencies than those in the conventional vibration generating device. Specifically, the vibration generating device 10 according to this embodiment employs a structure, in which the vibrating body 130 and the weight 135 are arranged in the right and left directions in the interior of the housing 110 and each of them is supported by an elastic support portion 140. By vibrating each of the vibrating body 130 and the weight 135 in the up and down directions and the right and left directions, it is possible to obtain vibrations due to a plurality of resonant frequencies (four or more).

As illustrated in FIGS. 1 to 3, the vibration generating device 10 is structured by including the housing 110, the vibration unit 120, the permanent magnets 151 and 152, and the FPC (Flexible Printed Circuits) 160.

The housing 110 is formed by processing a metal plate and is a box-like member substantially shaped like a rectangular parallelepiped. The housing 110 has a lower casing 111 and an upper casing 112 that are separable from each other. The lower casing 111 is a container-like member having an upper portion that has an upper opening. Other components (a vibration unit 120, permanent magnets 151, 152, and a FPC 160) are built in the lower casing 111. The upper casing 112 is a lid-like member that covers by the upper opening of the lower casing 111 to block the upper opening of the lower casing 111.

As illustrated in FIG. 1, an outer peripheral edge of the upper casing 112 is formed with a plurality (totally, six in the example illustrated in FIG. 1) of nail portions 112A in a flat plate-like shape projecting outwardly and horizontally in an unfolded state. Each nail portion 112A has a lateral rectangular shape at its tip portion and is substantially shaped like the letter T. Each nail portion 112A is folded downwardly at the right angle when the upper opening of the lower casing 111 is covered with the upper casing 112, so that the tip portion in the rectangular shape is fitted into an opening 111B having a substantially similar shape and size to that of the nail portion 112A formed in a side wall of the lower casing 111. Accordingly, the movement of the upper casing in the up and down directions (in the Z-axis direction in the figure), the right and left directions (in the X-axis direction in the figure), and the front and back directions (in the Y-axis direction in the figure) of the lower casing 111 is prevented by engagements with shear surfaces of the nail portions 112A. That is, the upper casing 112 is securely fixed to the lower casing 111.

The vibration unit 120 is a unit that generates vibration inside housing 110. The vibration unit 120 is configured with a vibrating body 130, a weight 135, and an elastic support portion 140.

The vibrating body 130 is an example of a “first vibrating body”. The vibrating body 130 has a magnetic core 131 and a coil 132 (an example of a “first magnetic generating unit” forming a “magnetic driving portion”) that form a prismatic electromagnet. The vibrating body 130 actively vibrates along the up and down directions (in the Z-axis direction in the figure) and the left and right directions (in the X-axis direction in the figure) in the interior of the housing 110 by generating an alternating magnetic field in the surrounding area by the electromagnet.

The weight 135 is an example of a “second vibrating body”. The weight 135 is a prismatic member having a predetermined weight. Inside the housing 110, the weight 135 vibrates in the up and down directions (in the Z-axis direction in the figure) and the right and left direction (in the X-axis direction in the figure) along the up and down directions (in the figure) and the right and left directions (in the X-axis direction in the figure) in response to vibration of the vibrating body 130.

The elastic support portion 140 is a member that supports the vibrating body 130 and the weight 135 in parallel with each other and elastically deforms the vibrating body in the up and down directions (in the Z-axis direction in the figure) and the right and left directions (in the X-axis direction in the figure) inside the housing 110 so as to enable vibration along the up and down directions (in the Z-axis direction in the figure) and the right and left directions (in the figure) by the vibrating body 130 and the weight 135.

The permanent magnets 151 and 152 are examples of “second magnetic generating unit” that forms the “magnetic driving portion”. The permanent magnets 151 and 152 are provided for creating the attractive force and repulsion force between the vibrating body 130 and the permanent magnets 151 and 152 inside the housing 110. The permanent magnet 151 is provided opposite one end (the negative end of the Y-axis in the figure) of the magnetic core 131 provided in the vibrating body 130. The permanent magnet 152 is provided opposite the other end (the end on the positive side of the Y-axis in FIG. 2) of the magnetic core 131 provided in the vibrating body 130.

The FPC 160 is an example of a “current-carrying unit” that allows the coil 132 to be energized from the outside. The FPC 160 is a member that connects the coil 132 with an external circuit (not illustrated) to supply an alternating current to the coil 132 provided by the vibrating body 130. The FPC 160 is a film-like member having a structure in which a wiring made of a metal film is sandwiched with a resin material such as polyimide. The FPC 160 is flexible and can be bent or deflected. The FPC 160 is disposed within the housing 110, except at the end of the external circuit side. Meanwhile, the end of the FPC 160 on the external circuit side is exposed to the outside of the housing 110 from an opening 110A formed in the housing 110 (between the lower casing 111 and the upper casing 112). The exposed portion has an electrode terminal made of a metal film for electrically connecting to an external circuit.

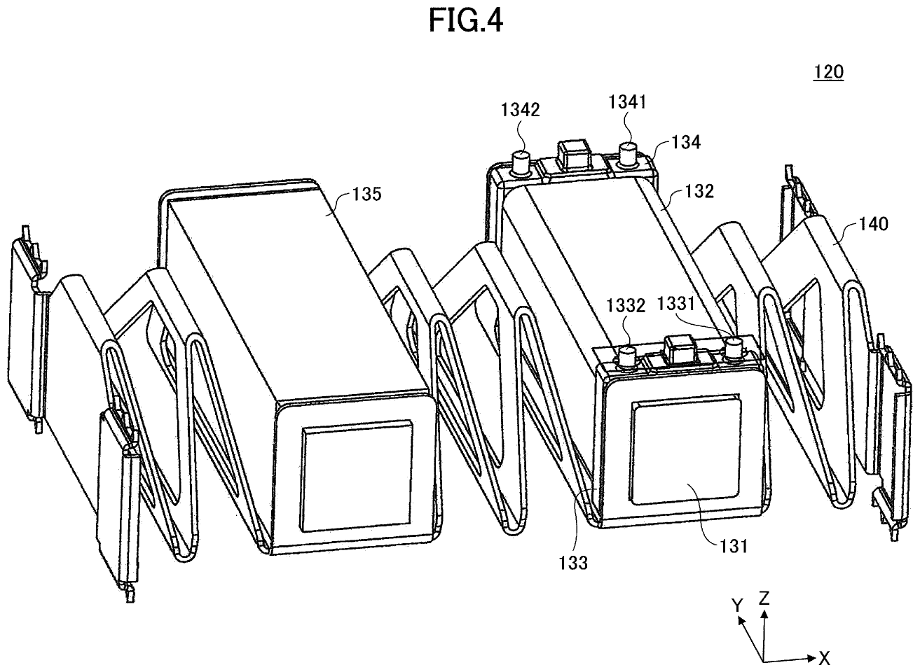

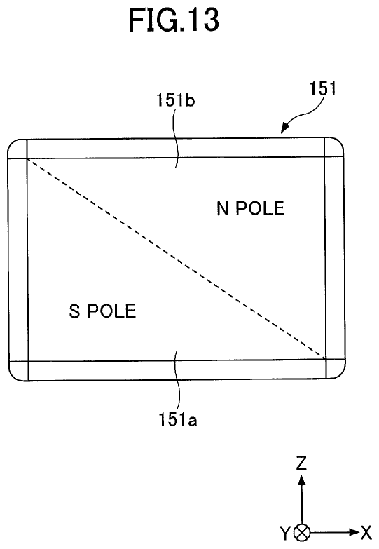

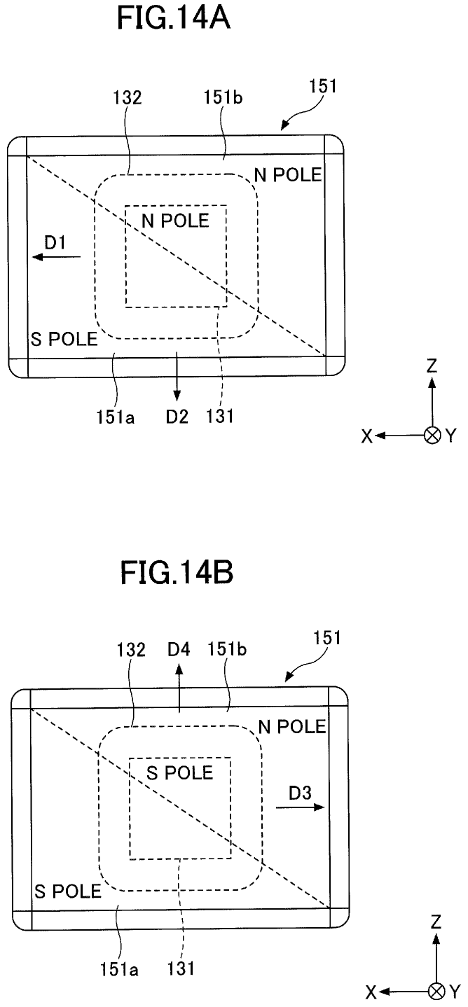

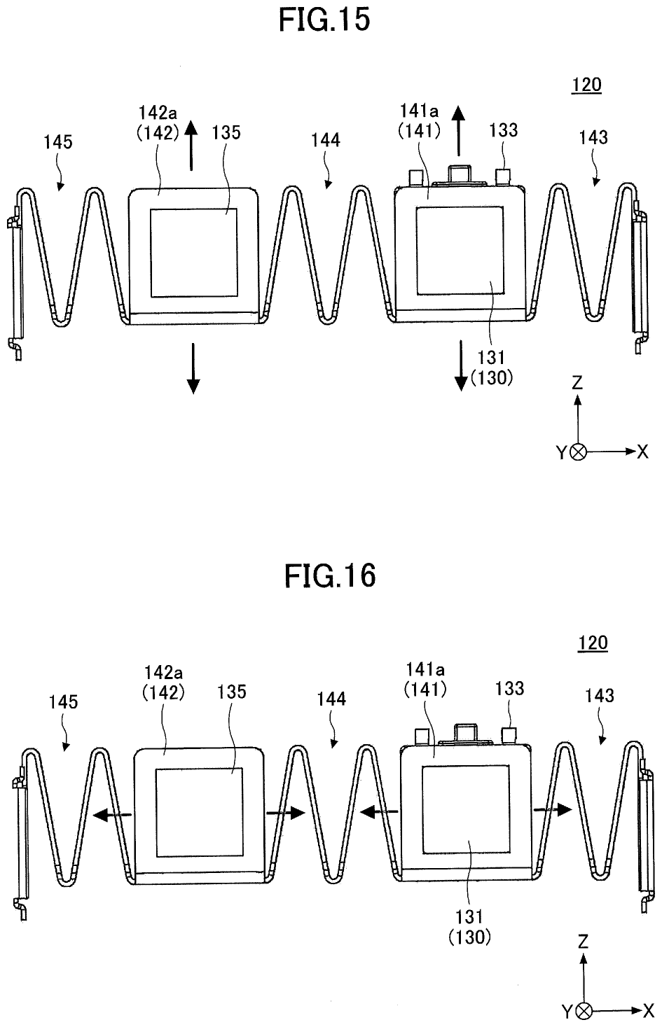

The vibration generating device 10 so configured is capable of generating an alternating magnetic field around the coil 132 by supplying alternating current to the coil 132 provided by the vibrating body 130 from an external circuit (not illustrated) through the FPC 160. Accordingly, the vibrating body 130 actively vibrates along the up and down directions (in the Z-axis direction in the figure) and the right and left direction (in the X-axis direction in the figure) while elastically deforming the elastic support portion 140 supporting the vibrating body 130 due to the attractive and repulsive forces generated between the vibrating body 130 and the permanent magnets 151 and 152. In addition, while elastically deforming the elastic support portion 140 supporting the weight 135, the weight 135 vibrates in the up and down directions (in the Z-axis direction in the figure) and the right and left directions (in the X-axis direction in the figure) along with vibration of the vibrating body 130. The vibration generating device 10 is capable of vibrating at a plurality of resonant frequencies (four or more) due to the combined vibration caused by the vibration of the vibrating body 130 and the vibration of the weight 135. The specific structure of the vibration unit 120 will be described later with reference to FIGS. 4 to 7. The specific structure of the elastic support portion 140 will be described later with reference to FIGS. 8 to 11. The specific Structures of the permanent magnets 151 and 152 will be described later with reference to FIGS. 13 and 14. The specific operation of the vibration unit 120 will be described below with reference to FIGS. 15 to 18.

### (Structure of Vibration Unit 120)

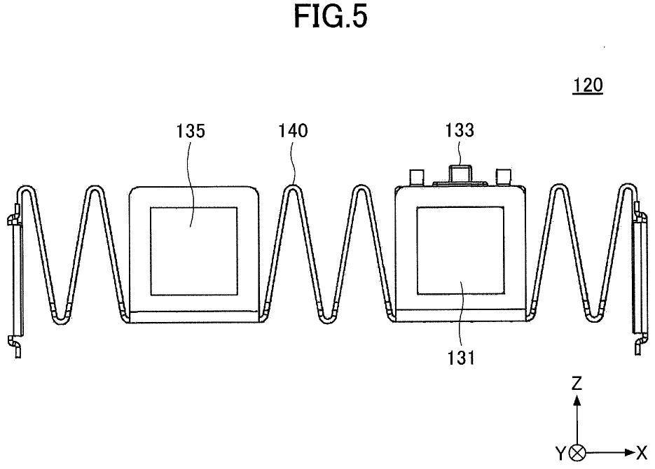

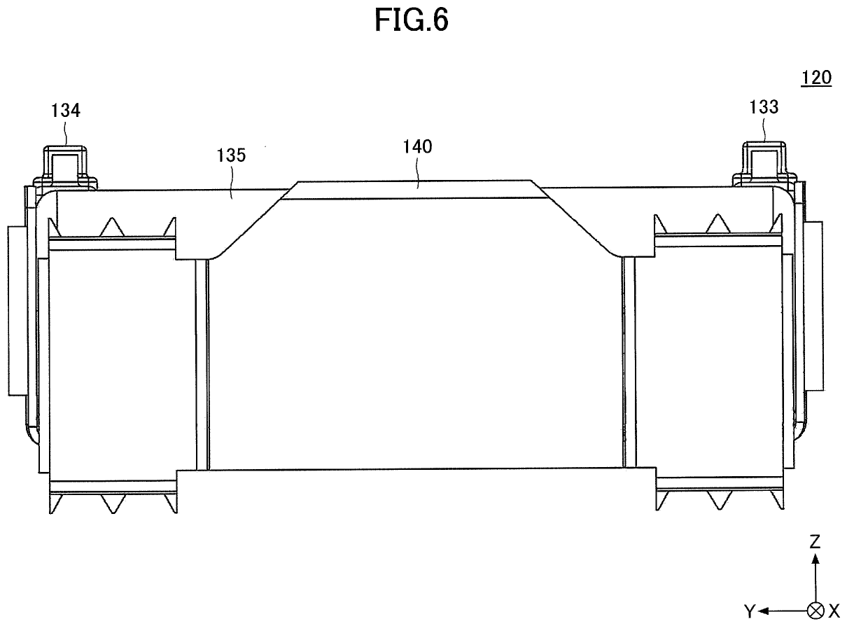

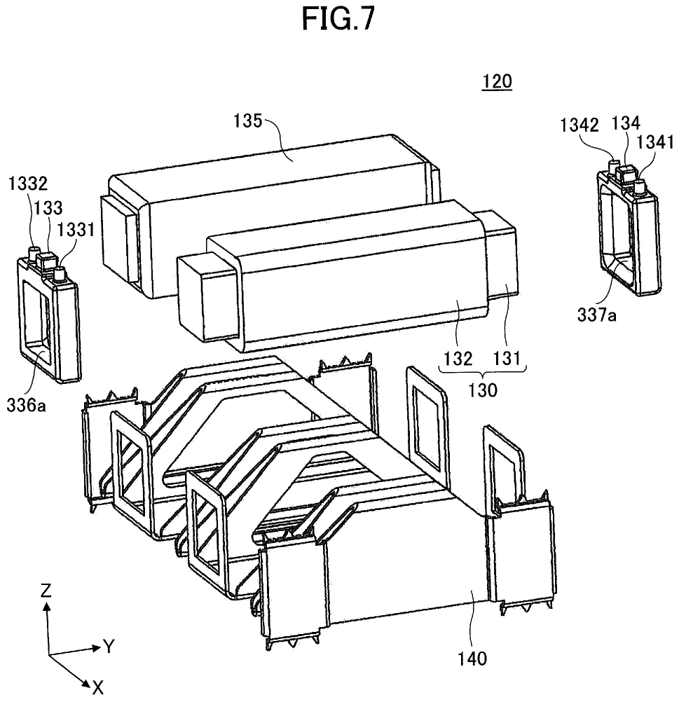

FIG. 4 is a perspective view illustrating the vibration unit 120 provided by a vibration generating device 10 according to an embodiment. FIG. 5 is a front view illustrating the vibration unit 120 provided by the vibration generating device 10 according to the embodiment. FIG. 6 is a side view illustrating the vibration unit 120 provided by a vibration generating device 10 according to the embodiment. FIG. 7 is an exploded view of the vibration unit 120 provided by the vibration generating device 10 according to the embodiment.

As illustrated in FIGS. 4 to 7, the vibration unit 120 is configured with the magnetic core 131, the coil 132, the flange 133, the flange 134, the weight 135, and the elastic support portion 140. The magnetic core 131, the coil 132, and the weight 135 are all members extending in the front and back directions (a second direction, Y-axis direction in the figure) intersecting the lateral direction (first direction, X-axis direction in the figure) that is the vibrating direction of the vibrating body 130.

The magnetic core 131 and coil 132 form the vibrating body 130. The magnetic core 131 is a prismatic member made from a ferromagnetic material such as iron. The coil 132 is formed by multiple windings of electric wires around the magnetic core 131. The wires forming the coil 132 are preferably made of a material with relatively low electrical resistance, for example, copper wires coated with an insulator are preferably used. The wires forming the coil 132 are connected to the FPC 160 by soldering or the like.

The vibrating body 130 generates an alternating magnetic field around the vibrating body 130 by supplying a current to the coil 132 from an external circuit via the FPC 160. Thus, the vibrating body 130 is magnetized so that one end of the magnetic core 131 and the other end of the magnetic core 131 become different magnetic poles, while the one end of the magnetic core 131 and the other end of the magnetic core 131 are alternately magnetized to the N and S poles.

The weight 135 is a prismatic member having a predetermined weight disposed parallel to the vibrating body 130. For example, the weight 135 may be made of metal material to ensure sufficient weight. In particular, it is preferable that the weight 135 be made of metal material having a relatively high specific gravity. For example, in this embodiment, the weight 135 is preferably made of iron used in the magnetic core 131 or tungsten having a higher specific gravity than copper used in the coil 132 as a preferred example of metal material having a relatively high specific gravity. The weight 135 in this embodiment is held at both ends by the elastic support portions 140 in the same manner as the magnetic core 131 of the vibrating body 130 and thus has the length in the longitudinal direction (Y-axis direction in FIG. 2) substantially the same as the magnetic core 131.

The flanges 133 and 134 are, for example, members made from an insulating material. The flange 133 retains one end (the end on the negative side of the Y-axis in FIG. 7) of the magnetic core 131 in the rectangularly-opened magnetic core retaining portion 336a. The flange 134 retains the other end (the end on the positive side of the Y-axis in FIG. 7) of the magnetic core 131 in the rectangularly-opened magnetic core retaining portion 337a.

Two protrusions 1331, 1332, 1341, and 1342 in a cylindrical shape are respectively formed on the top surfaces of the flanges 133 and 134. Each protrusion 1331, 1332, 1341, and 1342 can be retained together by winding of the end of the wire forming coil 132. Each protrusion 1331, 1332, 1341, and 1342 may also stably hold the FPC while positioning the FPC 160 in a predetermined position, for example, by inserting each protrusion 1331, 1332, 1341, and 1342 into a circular opening formed in the FPC 160.

The elastic support portion 140 is a member formed by machining a springy metal plate into a predetermined shape. The elastic support portion 140 supports the vibrating body 130 (with the magnetic core 131 retained by the flanges 133 and 134) and the weight 135 in parallel with each other and elastically deforms the vibrating body in the up and down directions (in the Z-axis direction in the figures) and the right and left directions (in the X-axis direction in the figures) to enable vibration along the up and down directions (in the Z-axis direction in the figures) and the right and left directions (in the figures) by the vibrating body 130 and the weight 135.

As described above, the vibration generating device 10 in this embodiment employs a structure in which the vibrating body 130 and the weight 135 are arranged side by side in the vibration unit 120 and each is supported by an elastic support portion 140. Accordingly, the vibration generating device 10 according to the present embodiment is capable of vibrating by a plurality of resonant frequencies (four or more) through combined vibration caused by active vibration of the vibrating body 130 and follow-up vibration of the weight 135.

### (Structure of Elastic Support Portion 140)

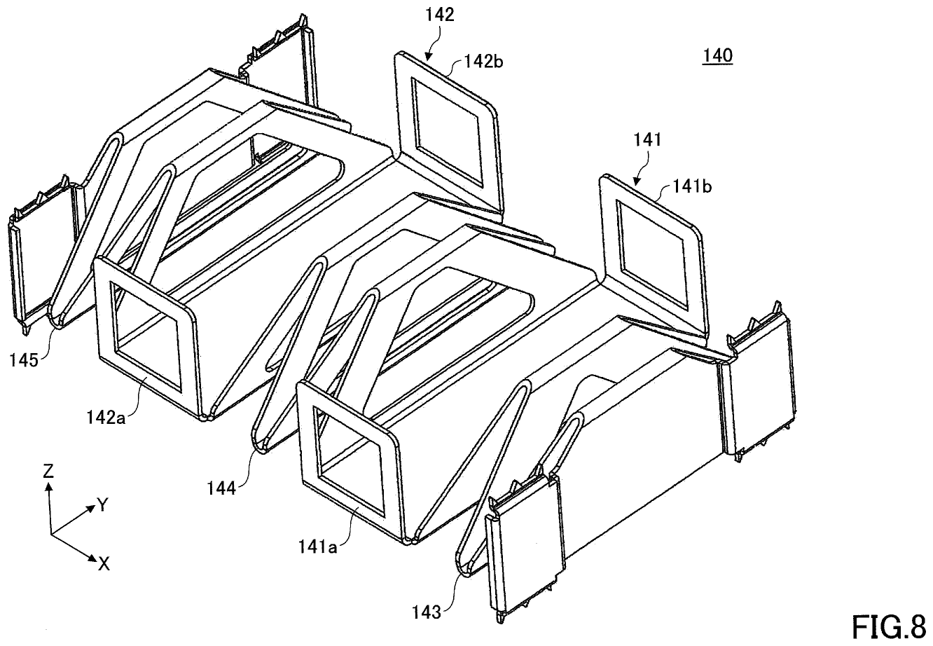

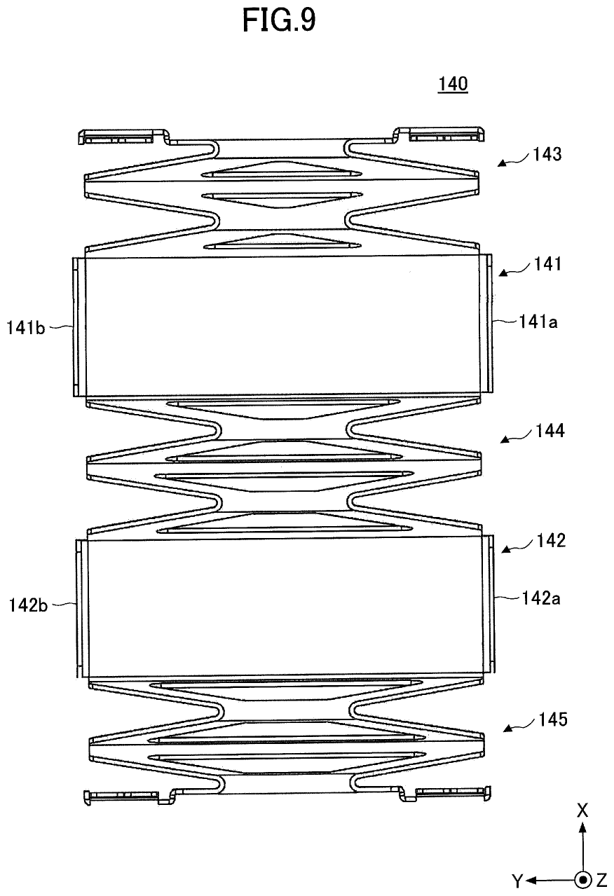

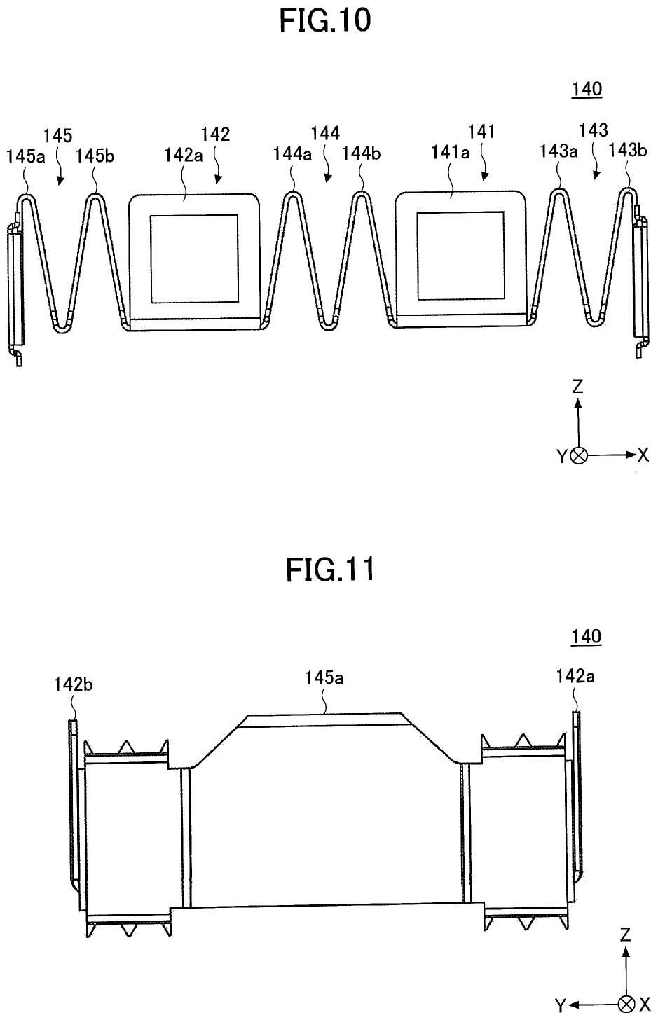

FIG. 8 is a perspective view illustrating an elastic support portion 140 included in the vibration generating device 10 according to the embodiment. FIG. 9 is a plan view illustrating an elastic support portion 140 installed in the vibration generating device 10 according to the embodiment. FIG. 10 is a front view illustrating the elastic support portion 140 installed in the vibration generating device 10 according to the embodiment. FIG. 11 is a side view illustrating the elastic support portion 140 provided by the vibration generating device 10 according to the embodiment.

As illustrated in FIGS. 8 to 11, the elastic support portion 140 is structured to include a first holding portion 141, a second holding portion 142, a first spring portion 143, a second spring portion 144, and a third spring portion 145. The elastic support portion 140 is integrally formed from a single metal plate including its components such as the first holding portion 141, the second holding portion 142, the first spring portion 143, the second spring portion 144, and the third spring portion 145.

The first holding portion 141 is a basket-like portion that holds the vibrating body 130. The first holding portion 141 is generally in a shape of rectangular when viewed from above. The first holding portion 141 has a first wall portion 141a and a second wall portion 141b. The first wall portion 141a is a wall-like portion that is vertically mounted in one of the shorter sides of the first holding portion 141 (the shorter side of the negative side of the X-axis in the FIGS. 8 and 9) and retains one end of the magnetic core 131 constituting the vibrating body 130 within a rectangular-shaped opening. The second wall portion 141b is a wall-like portion that is vertically mounted in the other short side portion of the first holding portion 141 (the short side portion of the Y-axis positive side in the figure) and retains the other end of the magnetic core 131 constituting the vibrating body 130 within a rectangular-shaped opening. The first wall portion 141a and the second wall portion 141b may be fixed to both ends of the magnetic core 131 by, for example, cutting and splitting both ends of the magnetic core 131 or swaging a rectangular opening.

The second holding portion 142 is a basket-like portion which holds the weight 135. The second holding portion 142 is generally rectangular in shape in a plan view viewed from the above. The second holding portion 142 has a first wall portion 142a and a second wall portion 142b. The first wall portion 142a is a wall-like portion that is vertically mounted at one of the shorter sides of the second holding portion 142 (the shorter side portion on the negative side of the Y-axis in the figure) and retains one end of the weight 135 within a rectangular-shaped opening. The second wall portion 142b is a wall-like portion that is vertically mounted in the other short side portion of the second holding portion 142 (the short side portion on the positive side of the Y-axis in the figure) and retains the other end of the weight 135 within a rectangular-shaped opening. The first wall portion 142a and the second wall portion 142b may be fixedly held at both ends of the weight 135, for example, by cutting and splitting both ends of the weight 135 or swaging the rectangular opening.

The first spring portion 143 is an example of a “first elastic body”. The first spring portion 143 is provided on the outer side of the left and right sides of the first holding portion 141 (the positive side of the X-axis in the figure) and is formed by folding the metal plate on the long side portion of the outside of the first holding portion 141 (the X-axis positive side in the figure) in the up and down directions (the Y-axis direction in the figure) multiple times in the up and down directions (the Z-axis direction in the figure) along folding lines running in the front and rear direction (the Y-axis direction in the figure). As illustrated in FIG. 10, the first spring portion 143 has a folded structure in which the two mountain portions 143a and 143b continue in the lateral direction (in the X-axis direction in the figure) when viewed frontward or backward. The first spring portion 143 functions as a so-called leaf spring and elastic deformation of the first spring portion 143 enables vibration of the vibrating body 130 in the up and down directions (in the Z-axis direction in the figure) and the right and left directions (in the X-axis direction in the figure).

The second spring portion 144 is an example of a “second elastic body”. The second spring portion 144 is provided between the first holding portion 141 and the second holding portion 142 and is a plate spring-like portion formed by bending a metal plate having a longitudinal side portion of the inside (the negative side of the X-axis in the figure) of the first holding portion 141 and a longitudinal side portion of the inside (the positive side of the X-axis in the figure) of the second holding portion 142 multiple times in the up and down directions (the Z-axis in the figure) by a bending line along the front and rear direction (the Y-axis in the figure). As illustrated in FIG. 10, the second spring portion 144 has a folded structure, in which the two mountain portions 144a and 144b are continuous in the lateral directions (in the X-axis direction in the figure) when viewed frontward or backward. The second spring portion 144 functions as a so-called leaf spring and elastic deformation of the second spring portion 144 enables vibration of the weight 135 in the up and down directions (in the Z-axis direction in the figure) and the right and left direction (in the X-axis direction in the figure) due to vibration of the vibrating body 130.

The third spring portion 145 is an example of a “third elastic body”. The third spring portion 145 is provided on the outer side between the left and right sides of the second holding portion 142 (the negative side of the X-axis in the figure) and is a plate spring-like portion formed by folding the metal plate on the long side portion of the outside of the second holding portion 142 (the negative side of the X-axis in the figure) several times in the up and down directions (the Z-axis in the figure) along a folding line running in the front and rear direction (the Y-axis in the figure). As illustrated in FIG. 10, the third spring portion 145 has a folded structure in which the two mountain portions 145a and 145b continue in the lateral direction (in the X-axis direction in the figure) when viewed frontward or backward. The third spring portion 145 functions as a so-called leaf spring and elastic deformation of the third spring portion 145 enables vibration in the up and down directions (in the Z-axis direction in the figure) and the right and left directions (in the X-axis direction in the figure) of the weight 135.

Here, since the first to third spring portions 143 to 145 have a bending structure, the spring portions are easily deformed in the direction perpendicular to the bending line (in the X-axis direction and the Z-axis direction in the figure), but are not easily deformed in the direction along the bending line (in the Y-axis direction in the figure).

Therefore, the above first to third spring portions 143 to 145 are elastically deformed in a right and left direction (in the X-axis direction in the figure) by expansion and contraction, and elastically deformed in a vertical direction (in the Z-axis direction in the figure) by deflection, but elastic deformation in the front and back directions (in the Y-axis direction in the figure) is suppressed.

For example, when the vibrating body 130 vibrates largely in the up and down directions, the first spring portion 143 and the second spring portion 144 largely flex in the up and down directions. For example, when the vibrating body 130 vibrates largely in the right and left directions, the first spring portion 143 and the second spring portion 144 are largely expanded and contracted in the right and left directions.

If, for example, the weight 135 vibrates largely in the up and down directions, the second spring portion 144 and the third spring portion 145 are largely flexed in the up and down directions. If, for example, the weight 135 vibrates largely in the right and left direction, the second spring portion 144 and the third spring portion 145 mainly and largely expand and contract in the right and left direction.

In addition, since the first to third spring portions 143 to 145 have a bending structure, elastic deformation in the right and left directions (in the X-axis direction in the figure) due to expansion and contraction is more easily deformed than elastic deformation in the upper and lower directions (in the Z-axis direction in the figure) due to deflection. Therefore, for example, when the elastic coefficient in the right and left directions (the X-axis direction in the figure) of the first to third spring portions 143 to 145 is set as the first elastic coefficient, and the elastic coefficient in the upper and lower directions (the Z-axis direction in the figure) of the first to third spring portions 143 to 145 is set as the second elastic coefficient, and the first elastic coefficient and the second elastic coefficient are different from each other.

Further, as illustrated in FIGS. 8 to 11, an opening is formed in each of the planar portions (i.e., each of the planar portions constituting the slope of each mountain portion) constituting each of the first to third spring portions 143 to 145. Each opening is shaped and sized to obtain the desired elastic coefficient by simulation or the like. For example, a trapezoidal opening of relatively small size is formed in the plane portion constituting the first spring portion 143. In addition, a trapezoidal opening of a relatively intermediate size is formed in the plane portion constituting the second spring portion 144. In addition, a trapezoidal opening of a relatively large size is formed in the plane portion constituting the third spring portion 145. Thus, each of the first to third spring portions 143 to 145 has a different elastic coefficient from each other. Specifically, the elastic modulus of the first spring portion 143 is higher than the elastic coefficient of the second spring portion 144, and the elastic coefficient of the second spring portion 144 is higher than the elastic coefficient of the third spring portion 145. In this case, since the vibrating body 130 vibrates actively, the weight 135 vibrates in a follow-up manner, the second and third spring portions 144 and 145 connected to the second holding portion 142 holding the weight 135 have relatively large openings to easily elastically deform in order to obtain a sufficient vibration amount of the weight 135. By adjusting the size of the opening in this manner, the first to third spring portions 143 to 145 can be integrally formed in the elastic support portion 140 without adjusting the elastic coefficient by the plate thickness or the material, thereby reducing the manufacturing cost and stabilizing the quality. Further, the elastic coefficient can be adjusted by adjusting the lengths of the first to third spring portions 143 to 145 in the longitudinal direction (the Y-axis direction in the figure), but the vibration in the longitudinal direction of the vibrating body 130 tends to increase as the length in the longitudinal direction decreases. On the other hand, by adjusting the size of the opening, it is possible to adjust the elastic coefficient while suppressing vibration in the front and rear directions without reducing the length in the front and rear directions. Accordingly, it is more preferable that each of the first to third spring portions 143 to 145 use a method of adjusting the elastic coefficient by the opening.

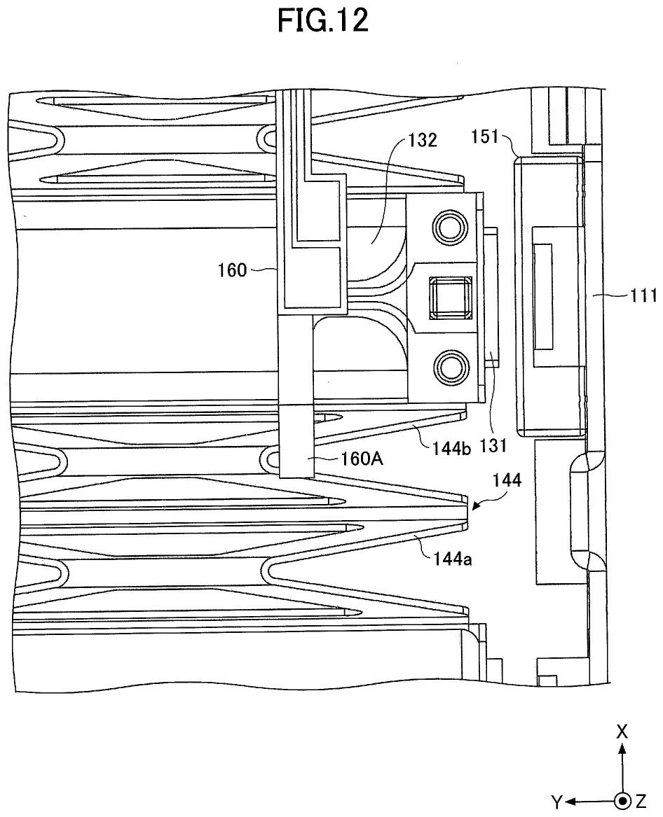

Further, as illustrated in FIGS. 8 to 11, each of the planar portions constituting the first to third spring portions 143 to 145 (i.e., each of the planar portions constituting the slope of each mountain portion) has a trapezoidal-shaped planar shape with a shorter upper side and a longer lower side. One advantage of having such a shape is that it avoids interference with the FPC 160. This point will be described with reference to FIG. 12. FIG. 12 is a partially enlarged view of the vibration generating device 10 according to the embodiment. As illustrated in FIG. 12, the FPC 160 has a folding portion 160A that is extended toward the external circuit side in a direction from a first direction (the negative direction of the X-axis in the figure) to a second direction (the positive direction of the X-axis in the figure), and the folding portion 160A protrudes from the inner space (the space on the negative side of the X-axis in the figure, that is, the space between the vibrating body 130 and the weight 135) than the vibrating body 130. Although the second spring portion 144 is provided in the space inside the vibrating body 130, the second spring portion 144 (the mountain portion 144b) has a trapezoidal planar shape (i.e., a planar shape that is gradually narrowed toward the center side as it moves toward the upper side). Therefore, the second spring portion 144 can be elastically deformed in the vertical direction and right and left directions while avoiding interference with the folding portion 160A due to the narrowed portion. Accordingly, the vibration generating device 10 according to the present embodiment can suppress damage to the FPC 160 caused by vibration of the vibrating body 130 and the weight 135. Particularly, in this embodiment, the second spring portion 144 connects the vibrating body 130 to the weight 135, and the spring portion tends to elastically deform in the up and down directions compared to the other spring portion. Therefore, the effect of avoiding interference with the folding portion 160A by making the planar shape of the spring portion a trapezoidal shape is more pronounced.

Incidentally, the plane portion located at both the left and right sides of the elastic support portion 140 has a vertical plane portion at both ends in the front and rear direction (the Y-axis direction in the figure), and the plane portion is fixed to the inner surface of the side wall portion of the housing 110 (the lower casing 111) by any fixing unit (for example, adhesive, rivet, screw, swaging, etc.). This ensures that the elastic support portion 140 is secured within the housing 110 while the vibrating body 130 and the weight 135 are held so as to be vibratable. (Magnetization state of permanent magnet 151)

FIG. 13 is a diagram for explaining the magnetization state of a permanent magnet 151 included in the vibration generating device 10 according to the embodiment. Here, the magnetization state of the permanent magnet 151 when the permanent magnet 151 is viewed from the negative side of the Y-axis in the figure will be described.

As illustrated in FIG. 13, the permanent magnet 151 is divided into two areas by a diagonal line extending from the upper left corner to the lower right corner when viewed in a plane from the negative side of the Y-axis in the figure, and these two areas are magnetized so that they have different polarities from each other. In the example illustrated in FIG. 13, the first magnetizing region 151a, which is the area on the left lower side of the permanent magnet 151, is magnetized to the S pole, and the second magnetizing region 151b, which is the area on the right upper side of the permanent magnet 151, is magnetized to the N pole.

Although not illustrated, the permanent magnet 152 sandwiched between the vibrating body 130 and the permanent magnet 151 is divided into two regions (the first magnetization region and the second magnetization region) by a diagonal line extending from the upper left corner to the lower right corner when viewed in a plane from the negative side of the Y-axis in the figure, similar to the permanent magnet 151. However, the permanent magnet 152, in contrast to the permanent magnet 151, is magnetized to the N pole in the first magnetization region, which is a region at the left lower side, and the second magnetization region, which is a region at the right upper side, is magnetized to the S pole.

### (Operation of Vibrating Body 130)

FIGS. 14A and 14B are diagrams illustrating the operation of the vibrating body 130 provided by the vibration generating device 10 according to the embodiment.

In the vibration generating device 10 of this embodiment, alternating magnetic fields are generated around the vibrating body 130 by applying an alternating current to the coil 132 forming the vibrating body 130, and both ends of the magnetic core 131 are magnetized so that both ends of the magnetic core 131 are polarized differently from each other.

For example, as illustrated in FIG. 14A, when one end of the magnetic core 131 (the negative end of the Y-axis in the figure) is magnetized to the N pole, an attractive force attracted to the first magnetizing region 151a (the S pole) of the permanent magnet 151 and a repulsive force repulsive to the second magnetizing region 151b (the N pole) of the permanent magnet 151 are generated at one end of the magnetic core 131. At the same time, the other end of the magnetic core 131 magnetized to the S pole generates an attractive force attracted to the first magnetized region (the N pole) of the permanent magnet 152 and a repulsive force repulsive to the second magnetized region (the S pole) of the permanent magnet 152. Thus, the vibrating body 130 moves in the left direction (in the direction of the arrow D1 in the figure) and the downward direction (in the direction of the arrow D2 in the figure) while elastically deforming the elastic support portion 140.

Meanwhile, as illustrated in FIG. 14B, when one end of the magnetic core 131 (the negative end of the Y-axis in the figure) is magnetized to the S pole, an attractive force attracted to the second magnetizing region 151b (the N pole) of the permanent magnet 151 and a repulsive force repulsive to the first magnetizing region 151a (the S pole) of the permanent magnet 151 are generated at one end of the magnetic core 131. At the same time, the other end of the magnetic core 131 at the N pole generates an attractive force attracted to the second magnetized region of the permanent magnet 152 and a repulsive force repulsive to the first magnetized region of the permanent magnet 152. Thus, the vibrating body 130 moves in the right direction (in the direction of the arrow D3 in the figure) and the upper direction (in the direction of the arrow D4 in the figure) while elastically deforming the elastic support portion 140.

Thus, in the vibration generating device 10 of the present embodiment, the direction of current flow to the coil 132 determines the direction of movement of the vibrating body 130 in the left direction and the downward direction, or in the right direction and the upward direction. Accordingly, in the vibration generating device 10 of this embodiment, by supplying an alternating current to the coil 132, the vibrating body 130 moves in the left direction (in the direction of the arrow D1 in the figure) and the downward direction (in the direction of the arrow D2 in the figure) as illustrated in FIG. 14A, and the vibrating body 130 moves in the right direction (in the direction of the arrow D3 in the figure) and the upward direction (in the direction of the arrow D4 in the figure) alternately as illustrated in FIG. 14B. Therefore, the vibrating body 130 actively vibrates in the up and down directions (the Z-axis direction in the figure) and the right and left direction (the X-axis direction in the figure).

### (Operation of Vibration Unit 120)

FIGS. 15 to 18 are diagrams illustrating the operation of the vibration unit 120 included in the vibration generating device 10 according to the embodiment. In FIGS. 15 to 18, the solid arrows represent relatively large vibrations, and the dotted arrows represent relatively small vibrations.

FIG. 15 illustrates the operation of the vibration unit 120 at the first resonant frequency of the vibration generating device 10. As illustrated in FIG. 15, when the vibrating body 130 is driven at the first resonant frequency, the vibrating body 130 and the weight 135 vibrate in the up and down directions (in the Z-axis direction in the figure) substantially the same as each other, so that the combined vibration caused by these vibrations produces a large vibration in the up and down directions (in the Z-axis direction in the figure) of the vibration generating device 10 as a whole.

FIG. 16 illustrates the operation of the vibration unit 120 at the second resonant frequency of the vibration generating device 10. As illustrated in FIG. 16, when the vibrating body 130 is driven at the second resonant frequency, the vibrating body 130 and the weight 135 vibrate substantially in the right and left directions (in the X-axis direction in the figure) to the same extent as each other, so that the combined vibration caused by these vibrations results in large vibrations in the left and right directions (in the X-axis direction in the figure) of the vibration generating device 10 as a whole.

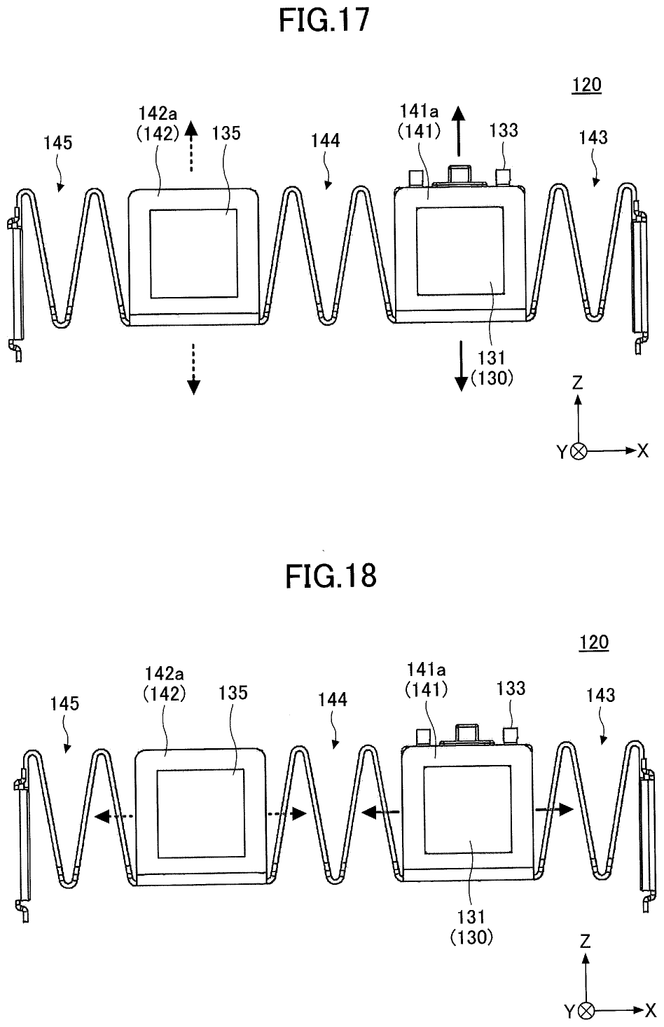

FIG. 17 illustrates the operation of the vibration unit 120 at a third resonant frequency of the vibration generating device 10. As illustrated in FIG. 17, when the vibrating body 130 is driven at the third resonant frequency, the vibrating body 130 vibrates significantly in the up and down directions (in the Z-axis direction in the figure), while the weight 135 vibrates small in the up and down directions (in the Z-axis direction in the figure), so that the combined vibration caused by these vibrations results in a large vibration in the up and down directions (in the Z-axis direction in the figure) of the entire vibration generating device 10.

FIG. 18 illustrates the operation of the vibration unit 120 at a fourth resonant frequency of the vibration generating device 10. As illustrated in FIG. 18, when the vibrating body 130 is driven at the fourth resonant frequency, the vibrating body 130 vibrates largely in the right and left directions (the X-axis direction in the figure), while the weight 135 vibrates small in the right and left directions (the X-axis direction in the figure), so that the combined vibration caused by these vibrations produces a large vibration in the left and right directions (the X-axis direction in the figure) as a whole of the vibration generating device 10.

The first to fourth resonant frequencies are determined by the mass of the vibrating body 130 and the weight 135, the material and the plate thickness of the elastic support portion 140, and the elastic coefficients of the first to third spring portions 143 to 145 of the elastic support portion 140. Accordingly, the vibration generating device 10 according to the present embodiment can adjust at least one of these parameters by a simulation or the like to set the first to fourth resonant frequencies as the target frequencies or to adjust the intensity of the vibrations. That is, the vibration generating device 10 according to this embodiment can be applied to various applications by performing such adjustment of resonant frequency.

### (Vibration Characteristics of Vibration Generating Device 10)

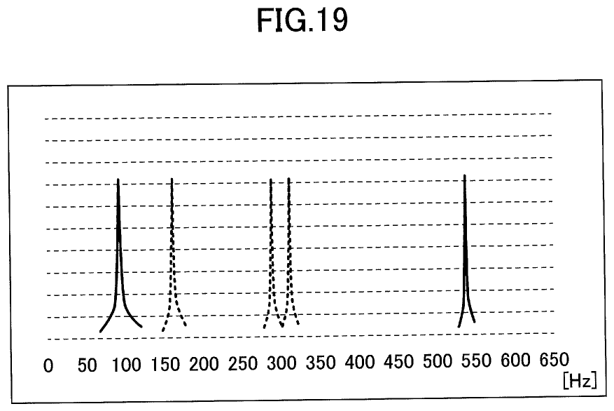

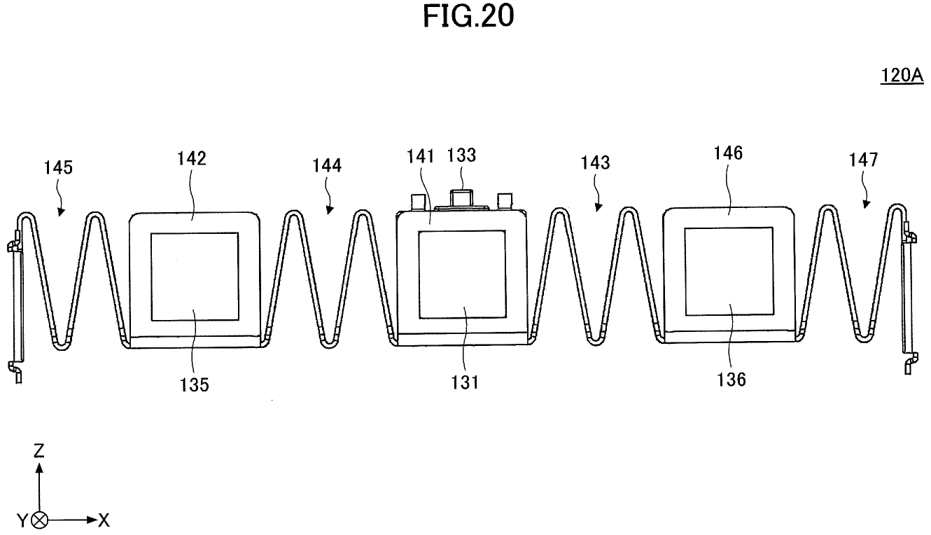

FIG. 19 is a graph illustrating the vibration characteristics of the vibration generating device 10 included in the vibration generating device 10 according to the embodiment. The vibration characteristics illustrated in FIG. 19 were actually confirmed by the inventors by conducting tests such as simulation using the vibration generating device 10 of the embodiment. In the graph illustrated in FIG. 19, the abscissa axis indicates the frequency and the ordinate axis indicates the acceleration of the vibration. In the graph illustrated in FIG. 19, a solid line represents vibration in the up and down directions, and a dotted line represents vibration in the right and left direction. As illustrated in FIG. 19, it has been confirmed by the inventors in this test that the vibration generating device 10 can generate vibrations at at least four different resonant frequencies (first to fourth resonant frequencies) in the frequency band below 1 kHz, which is more sensitive to biological bodies. In this test, the vibrating body 130 and the weight 135 have approximately the same mass as each other.

While one embodiment of the invention has been described in detail above, the invention is not limited to these embodiments, and various modifications or variations are possible within the scope of the invention as defined in the appended claims.

For example, the structure of each of the first to third spring portions of the elastic support portion (for example, the number of bends, the planar shape, the shape of the opening, the size, the presence or absence, etc.) is not limited to those described in the above-described embodiments. That is, the structure of each of the first to third spring portions may be appropriately modified depending on the various specifications of the vibration generating device (e.g., desired resonant frequency, size limitation of the housing, etc.).

For example, in the above-described embodiment, the coil 132 is disposed on the side of the vibrating body 130 as the “first magnetic generating unit”, and permanent magnets 151 and 152 are disposed on the side of the housing 110 as the “second magnetic generating unit”. That is, a permanent magnet may be disposed on the vibrating body 130 side as the “first magnetic field generating unit” and a coil may be disposed on the housing 110 side as the “second magnetic field generating unit”.

For example, in the above-described embodiment, the first and second magnetic generating unit are provided as the “first vibrating body” while the weight 135 is provided as the “second vibrating body” but third and fourth magnetic generating unit having the same structure as the first and second magnetic generating unit instead of the weight 135 may be provided as the “second vibrating body”. As a result, both the “first vibrating body” and the “second vibrating body” can be actively vibrated, so that the “second vibrating body” can be vibrated more and the vibration unit 120 can be vibrated at a resonant frequency different from the above-described first to fourth resonant frequencies.

For example, in the above-described embodiment, two vibrating bodies are disposed side by side in the vibration unit, and the vibration units are connected to each other by the elastic body. However, the above-described embodiment is not limited thereto. For example, as illustrated in FIG. 20, three vibrating bodies are disposed in a side-by-side manner in the vibration unit, and the vibrating bodies are connected to each other by the elastic body. With this, the vibration generating device that vibrates at a greater number of the resonant frequencies than that in the above-described embodiment can be substantialized. The vibration unit may be provided with four or more vibrating bodies.

### (Modification of Structure of Vibration Unit 120)

FIG. 20 is a front view illustrating a variation of the vibration unit 120 included in the vibration generating device 10 according to the embodiment.

The vibration unit 120A illustrated in FIG. 20 differs from the vibration unit 120 in that a weight 136 is further provided as a “third vibrating body”. Accordingly, the vibration unit 120A has a structure in which the weights 135 and 136 are arranged side by side on both sides of the vibrating body 130 in the left and right directions (the X-axis direction in the figure).

Accordingly, the elastic support portion 140 is additionally provided with a third holding portion 146 for holding the weight 136 and a fourth spring portion 147 (“fourth elastic body”), on the outside of the first spring portion 143 (the positive side of the X-axis in the figure). The third holding portion 146 has a structure similar to the second holding portion 142. The fourth spring portion 147 has a structure similar to the third spring portion 145. The first spring portion 143 is changed to a structure similar to the second spring portion 144.

According to this variation, for example, when vibrating the vibrating body 130 in the up and down directions (the Z-axis direction in the figure), the weights 135 and 136 vibrate in the up and down directions following the vibration, and the combined vibration by one or more combinations of the three vibrating bodies provides a large vibration in the up and down directions at three or more resonant frequencies of the vibration generating device 10 as a whole.

For example, when vibrating the vibrating body 130 in the right and left directions (the X-axis direction in the figure), the weights 135 and 136 vibrate in the left and right directions following the vibration, and combined vibration by one or more combinations of the three vibrators results in large vibrations in the left and right directions at three or more resonant frequencies of the vibration generating device 10 as a whole.

### [Effects of the Invention]

According to the embodiments, the vibration generating device that is capable of generating vibrations at a greater number of the resonant frequencies can be provided.

### DESCRIPTION OF SYMBOLS

10 Vibration generating device
110 Housing
111 Lower casing
112 Upper casing
120 Vibration unit
130 Vibrating body (first vibrating body)
131 Magnetic core
132 Coil (first magnetic generating unit)
133,134 Flange
135 Weight (second vibrating body)
140 Elastic support portion
141 First holding portion
142 Second holding portion
143 First spring portion (first elastic body)
144 Second spring portion (second elastic body)
145 Third spring portion (third elastic body)
151,152 Permanent magnet (second magnetic generating unit)
160 FPC

What is claimed is:

1. A vibration generating device comprising:
a housing;
a first vibrating body and a second vibrating body that are received inside the housing so as to be arranged in a first direction;
an elastic support portion supporting the first vibrating body and the second vibrating body so as to be vibratable along the first direction and a second direction intersecting the first direction; and
a magnetic drive portion including a first magnetic generating unit provided in the first vibrating body and a second magnetic generating unit provided in the housing, the magnetic drive portion being configured to drive the first vibrating body along the first direction and the second direction using magnetic force,
wherein the elastic support portion includes
a first elastic body coupling the first vibrating body to the housing so that the first vibrating body is movable in the first direction and the second direction,
a second elastic body coupling the first vibrating body to the second vibrating body, and
a third elastic body coupling the second vibrating body to the housing so that the second vibrating body is movable in the first direction and the second direction.

2. The vibration generating device according to claim 1,
wherein each of the first elastic body, the second elastic body, and the third elastic body is a leaf spring having a folded structure.

3. The vibration generating device according to claim 2,
wherein each of the first elastic body, the second elastic body, and the third elastic body has an opening in a flat surface portion constituting the leaf spring.

4. The vibration generating device according to claim 3,
wherein the openings of the first elastic body, the second elastic body, and the third elastic body make elastic coefficients mutually different.

5. The vibration generating device according to claim 4,
wherein the elastic coefficient of the first elastic body is higher than elastic coefficient of the second elastic body, and
wherein the elastic coefficient of the second elastic body is higher than the elastic coefficient of the third elastic body.

6. The vibration generating device according to claim 2,
wherein the elastic support portion includes the first elastic body, the second elastic body, and the third elastic body, and is integrally formed from a sheet of metal plate.

7. The vibration generating device according to claim 1,
wherein the first magnetic generating unit is one of a coil and a magnet,
wherein the second magnetic generating unit is the other one of the coil and the magnet.

8. The vibration generating device according to claim 1,
wherein the first vibrating body and the second vibrating body have substantially a same mass.

9. The vibration generating device according to claim 1, the vibration generating device further comprising:
a third vibrating body received in the housing so as to be arranged in the first direction together with the first and second vibrating bodies,
wherein the elastic support portion supports the first vibrating body, the second vibrating body, and the third vibrating body along the first direction and the second direction so as to be vibrated.

10. A vibration generating device comprising:
a housing;
a first vibrating body and a second vibrating body that are received inside the housing so as to be arranged in a first direction;
an elastic support portion that supports the first vibrating body and the second vibrating body so as to be vibratable along the first direction and a second direction intersecting the first direction; and
a magnetic drive portion including a first magnetic generating unit provided in the first vibrating body and a second magnetic generating unit provided in the housing, the magnetic drive portion being configured to drive the first vibrating body along the first direction and the second direction using magnetic force,
wherein the elastic support portion includes a vibration unit configured by including the first vibrating body, the second vibrating body, and the elastic support portion has a plurality of resonant frequencies for each of the first direction and the second direction.

11. The vibration generating device according to claim 10,
wherein the vibration unit has a first resonant frequency at which the first vibrating body and the second vibrating body vibrate in the first direction to substantially a same degree from each other,
a second resonant frequency at which the first vibrating body and the second vibrating body vibrate in the second direction to substantially the same degree from each other,
a third resonant frequency at which the first vibrating body vibrates in the first direction larger than the second vibrating body, and
a fourth resonant frequency at which the first vibrating body vibrates in the second direction larger than the second vibrating body.
